(19) United States
(12) Patent Application Publication
(10) Pub. No.: US 2004/0003947 A1
(43) Pub. Date: Jan. 8, 2004

(54) Handheld electronic scale with touch screen

(76) Inventors: Joshua D. Kesselman, Vancouver (CA); Horace Chung, Hong Kong (HK)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/264,874

(22) Filed: Oct. 4, 2002

Related U.S. Application Data
(60) Provisional application No. 60/393,468, filed on Jul. 2, 2002.

(51) Int. Cl. G01G 19/22; G01G 19/34

(52) U.S. Cl. 177/25.13

(57) ABSTRACT

The hand held scale of the present invention comprises a rectangular casing with a weighing platform, for supporting items to be weighed, a touch display screen, for displaying the weight of the objects and controlling the functions for the scale, and the electronic components for controlling such. The scale is preferably an electronic scale, where downward forces on the weighing platform are sensed by a transducer which produces an electrical signal indicative of weight. The visual display is touch screen. The touch screen display controls the calculator of the scale, which can also perform arithmetic calculations on the results of the weighing function. The calculator function can be used to perform price calculation based on unit price and the weight of the object. For example, the weight of the object can be transferred to the calculator function by depressing the weight on the touch screen display. The weight can then be multiplied by the unit price to determine the total price. If the weight is changed, the total price figure will also be updated instantly.

### CROSS-REFERENCE TO RELATED APPLICATIONS

This application claims the benefit of U.S. Patent Application serial No. 60/393,468 filed on Jul. 2, 2002, incorporated herein by reference.

### FIELD OF THE INVENTION

The present invention relates to electronic scales. More specifically, a scale which comprises a flat, compact and portable housing construction capable of providing a digital display of an object's weight, wherein the scale includes electronic circuitry and a touch screen for controlling the operating functions.

### BACKGROUND ART

There are a number of patents for scales including U.S. Pat. Nos. 4,034,818; 4,041,289; 4,195,348; 4,495,581; 4,800,973; 6,177,929; 6,295,198; and 6,381,484, incorporated herein by reference.

Typically, with an electronic scale, an object is positioned on a weighing platform, so that the weight of the object causes the weighing platform to move downward. The downward force causes the weighing platform to exert a force or pressure on a transducer. The transducer converts the downward force into an analog signal in terms of a voltage or a current having a magnitude which varies according to the weight of the object.

This analog signal cannot be easily converted for digital display purposes without the use of an analog to digital converter (A/D converter). Essentially, the prior art shows many techniques for performing analog to digital conversion. Primarily, the object of such devices is to respond to an analog signal to provide therefrom a digital code or a digital signal, which can be processed by conventional digital circuitry to eventually activate a digital display, such that, the weight of the object is displayed on the display screen.

### BRIEF SUMMARY OF THE INVENTION

The hand held scale of the present invention comprises a rectangular casing with a weighing platform, for supporting items to be weighed, a display screen, for displaying the weight of the objects and controlling the functions for the scale, and the electronic components for controlling such. The scale is preferably an electronic scale, where downward forces on the weighing platform are sensed by a transducer which produces an electrical signal indicative of weight. The visual display is also a touch screen.

In one aspect of the invention, a portable electronic weighing device is provided which includes (a) a platform on which an object is placed for weighing; (b) weighing circuitry in communication with the platform for weighing objects placed on the platform to provide weight data thereof; (c) a display having a first and second display area, the first display area for digital display of weight data of the object, and wherein the display further comprises an input device for receiving input from a user; and (d) calculating circuitry responsive to the input device and the weighing circuitry for providing output data, the output data displayed on the second display area; wherein the weight data is selectively transferred to the calculating circuitry through the input device by the user upon a single command without re-entering the weight data.

In a further aspect of the invention, the weighing circuitry includes a transducer coupled to the platform responsive to the weight of the object to provide an analog signal indicative of the weight, and comprising analog to digital conversion circuitry for providing the weight data. Further, in another aspect thereof, the input device includes a touch screen having a plurality of touch points thereon responsive to user input. A touch point is associated with the first display area such that when the touch point is activated, the weight data shown on the first display area is transferred to the calculating circuitry. The calculating circuitry includes mathematical functions operable on the weight data. The mathematical functions include arithmetic calculations operable via the touch screen, the results of which are displayed in the second display area. Moreover, the calculating circuitry further includes storage circuitry to allow storage of weight data and output data. In an embodiment, the calculating circuitry comprises price calculation circuitry, wherein the price calculation circuitry includes computing devices for receiving unit price, receiving weight data of an object placed on the platform, performing price calculation based on unit price and weight data, and displaying price calculation on the display. The price calculation circuitry automatically updates the price calculation upon receiving a change in weight data by performing price calculation based on unit price as previously received and newly received weight data, and displaying price calculation on the display.

The invention further includes a method for price calculation based on weight of an object including: (a) placing an object on a platform to be weighed; (b) weighing the object with a weighing device in communication with the platform providing digital weight data; (c) displaying the digital weight data on a first display area; (d) entering a unit price for the object, the unit price displayed on a second display area; (e) calculating the price based on the digital weight data and unit price by a single command by a user without re-entering the digital weight data; and (f) displaying the price on the second display area. In one aspect of the invention, the single command is entered by a touch screen. New price calculation is automatically provided upon placing another object on the platform having a different weight.

In the present invention, the functionality of the invention is operable through the display screen which is a multifunction touch screen display which is controlled by a microprocessor and connected to a power source, where the operational modes include a weighing function and a calculator function. For example, the touch screen display enables the weight of an object to be selectively displayed in a variety of units, including, grams, ounces, troy ounces, and pennyweight by depressing the MODE key. Additionally, the touch screen display controls a digital calculator of the scale, which can perform standard arithmetic calculations (i.e., +, −, ×, ÷). The calculator function can be used to perform price calculations based on unit price and the weight of the object. For example, the weight of the object can be transferred to the calculator function by depressing the weight on the touch screen display. The weight can then be multiplied by the unit price to determine the total price. If the weight is changed, the total price figure will also be updated instantly. In an embodiment, the hand held scale of the subject invention comprises an electronic scale and a display means for digitally displaying the weight of an object, wherein the scale and the display means are controlled by a micro-processor.

All patents, patent applications and publications referred to or cited herein, or from which a claim for benefit of priority has been made, are incorporated by reference in their entirety to the extent they are not inconsistent with the explicit teachings of this specification, including: U.S. Pat. No. 4,041,289, Brosh et al.; U.S. Pat. No. 4,800,973, Angel; U.S. Pat. No. 6,395,198 B1, Loh et al.; and U.S. Pat. No. 4,041,289.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A depicts a top view of the sample digital scale in accordance with one aspect of the present invention.

FIG. 1B depicts a side view of the sample digital scale in an open position in accordance with one aspect of the present invention.

FIG. 1C depicts a side view of the sample digital scale in a closed position in accordance with one aspect of the present invention.

FIG. 1D depicts a bottom view of the sample digital scale in a closed position in accordance with one aspect of the present invention.

FIG. 1E depicts a top view of the sample digital scale in a closed position in accordance with one aspect of the present invention.

FIG. 2 depicts a block diagram of a sample digital scale in accordance with one aspect of the present invention.

FIGS. 3a-3b depict the touch screen of the sample digital scale in accordance with one aspect of the present invention.

### DETAILED DISCLOSURE OF THE INVENTION

Referring now to the drawings, embodiments of the present invention will be described.

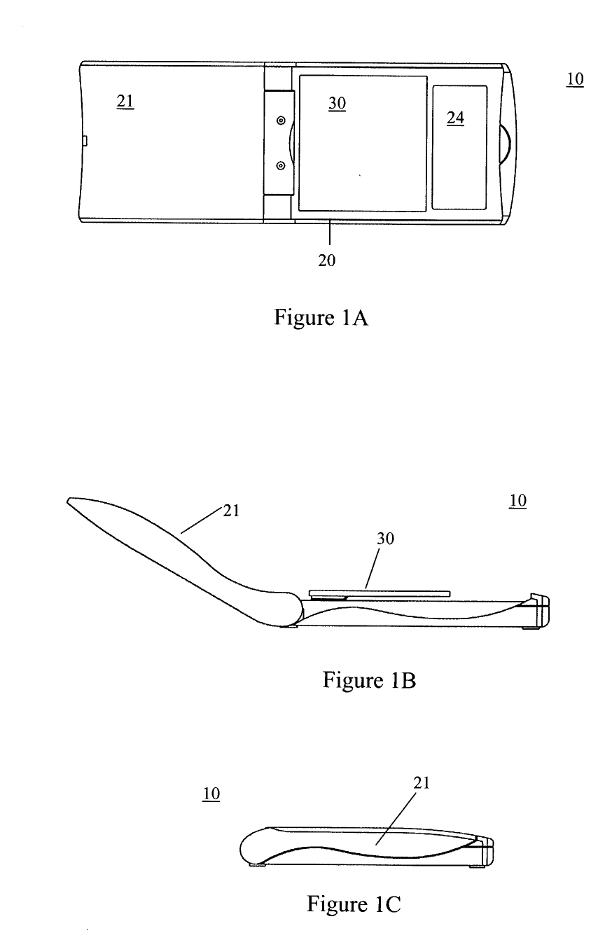

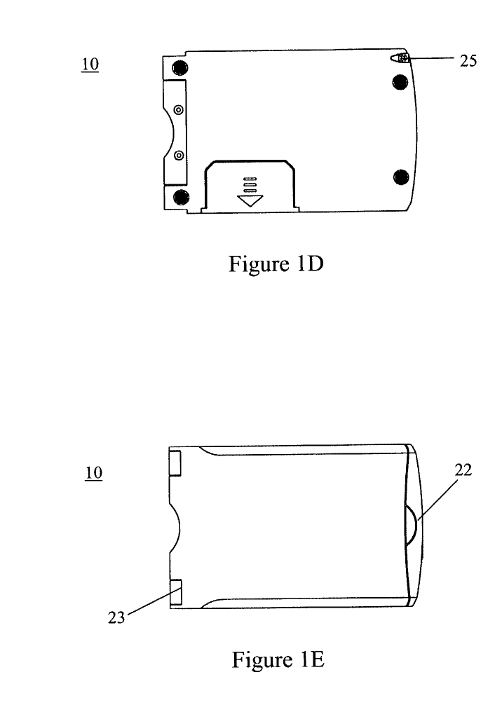

With reference to FIGS. 1A-1E, the hand held scale 10 of the present invention comprises a rectangular casing 20 comprising a weighing platform 30, for supporting items to be weighed, a display screen 24, for displaying the weight of the objects and other data, and controlling the functions for the scale 10 through a touch screen 40 incorporated with the display screen. The scale 10 includes a hinged lid 21 that opens on hinges 23 using latch 22. A stylus 25 for operating the touch screen 40 is also included.

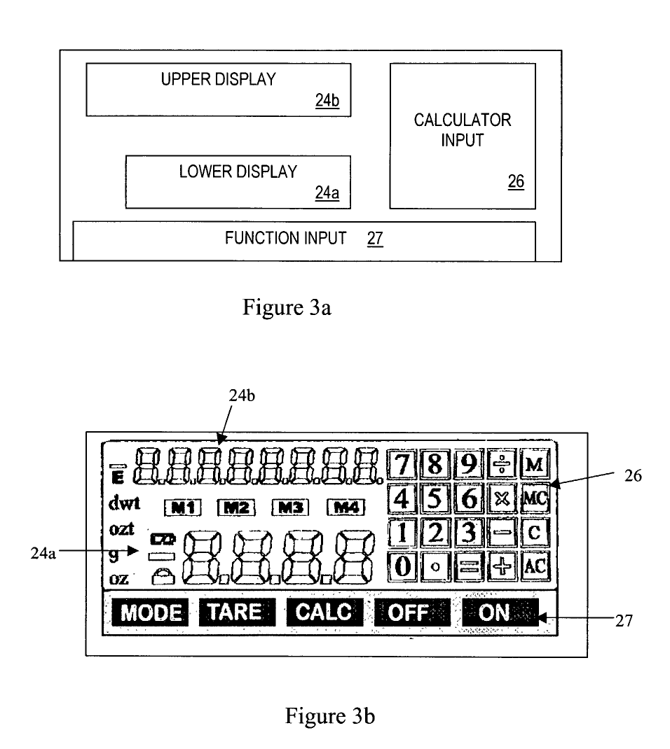

As shown in more detail in FIGS. 3a-3b, the display screen preferably includes at least two display areas 24a and 24b. The first display area 24a displays the weight of the object. The second display area 24b displays other data calculated by the circuitry of the invention. The location of the display areas 24a and 24b may be arranged as a matter of design choice. In the example provided herein, display area 24a is shown as a lower display row and display area 24b is shown as an upper display row. A calculator input section 26 of the display screen 24 is also included to allow user input of numerical entries and arithmetic operators. A function input section 27 is included to allow input of functions of the invention. Additional display indicators and touch points may be provided to provide for standard informational icons (e.g., error, units, battery level indicator, etc.) and additional inputs (e.g., memory recall icons) as known in the art.

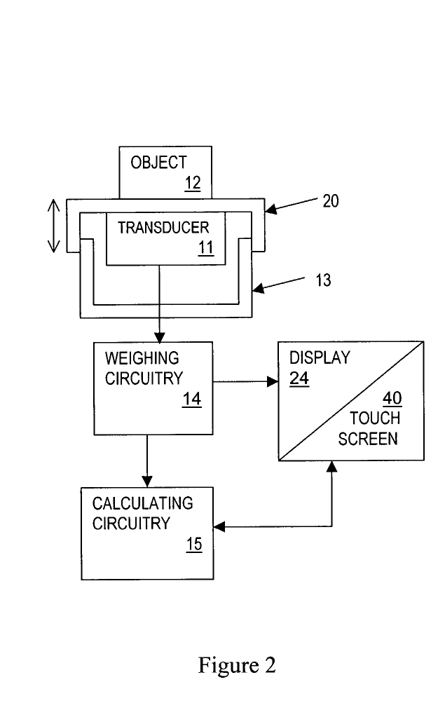

Turning now to FIG. 2, the scale 10 is preferably an electronic scale 10, where downward forces on the weighing platform 30 are sensed by a transducer 11 which produces an electrical signal indicative of weight. Weighing circuitry 13 transmits this signal to the display 24. The visual display 24 is touch screen 40. The electronic components of the scale 10 are positioned within the rectangular case 20. As shown, an object 12 is positioned on a weighing platform 30. The weighing platform 30 is associated with a base member 13, which is positioned on a horizontal reference plane. The object 12 causes the weighing platform 30 to move downwardly with respect to the plane or base 13. The downward force of the weight of the object 12 causes the weighing platform 30 to exert a force or pressure on a transducer 11 coupled between the weighing platform 30 and the base 13. The weighing platform 30 and base member 13 are conventional scale components and many examples of suitable apparatus exist in the prior art and may be used herein.

The transducer 11 or load cell can be a number of different devices for converting a pressure or a force into an electrical signal as known in the art. As such, the transducer 11 may compromise a Wheatstone bridge configuration employing piezoresistive elements or other pressure converting devices to provide a varying electrical signal indicative of the weight of the object 12 on the weighing platform 30. As such, the transducer 11 supplies an analog signal in terms of a voltage or a current having a magnitude which varies according to the weight of the object 12.

This analog signal cannot be easily converted for digital display purposes without the use of an analog to digital converter (A/D converter). Essentially, the prior art shows many techniques for performing analog to digital conversion, any of which may be used herein. Such devices respond to an analog signal to provide a digital code or a digital signal, which can be processed by conventional digital circuitry to eventually activate a digital display, such that, the weight of the object 12 is displayed on the display screen 24.

Calculating circuitry 15 is included with the scale 10 to provide the functions of the invention. The calculating circuitry communicates with the display 24 and receives input from the touch screen 40.

Referring to FIGS. 2 and 3a-3b, the weight of an object 12 is displayed on the display screen 24, at lower display row 24a where the display screen 24 is a multifunction touch screen display 40. The operation modes of the scale 10 and touch screen 40 are controlled by a microprocessor and connected to a power source, where the operational modes include a weighing function and a calculator function. For example, the touch screen display 40 enables the weight of the object 12 to be selectively displayed in a variety of units, including, grams, ounces, troy ounces, and pennyweight by depressing the MODE key. A stylus 22 is provided for contacting the touch screen 40 and thereby controlling the functions of the electronic scale 10.

In a method of use, the scale 10 is initially, turned on by pressing the ON key in the function input section 27. After a few seconds, the lower display row 24a will read “0.0 g”. Typically, the scale 10 should be allowed to warm up for at least 30 seconds before weighing for accuracy and stability. To weigh an object 12, the object 12 is placed on the center of the platform 30 and the value is shown on the lower display row 24a.

If you need to weigh loose items or anything in a container or tray the TARE function should be used to zero the scale. There are two ways to use the TARE function: 1) turn the scale ON; 2) place the empty container or tray on the platform 30; 3) press the TARE key in the function input section 27—the lower display row 24a will change to “0.0”; 4) place the objects 12 to be weighed into the container/tray; 5) the exact weight of the objects 12 will be displayed.

An alternative method for zeroing the scale 10 is to turn the scale OFF, place the tray to be tarred onto the platform 30, then turn the scale ON. The scale 10 will automatically tare the tray and “0.0” will displayed.

Another function of the scale 10 is an Auto-Off feature that turns off the scale 10 after lapses of non-activity. If the scale 10 is in a room with wind or air movement, it may sense the pressure of the air and not utilize Auto-Off. In this case, simply press the OFF button to turn the scale off manually.

This scale has the ability to weigh in grams, ounces, pennyweights or troy ounces. Simply press the MODE key in the function input section 27 once the scale is on. (The g, oz, dwt, or ozt is shown on the left of the display to determine mode). A unique feature of the invention is the price calculations. The calculator function on the touch screen at calculator input 26 can be used to perform price calculation based on unit price and the weight of the object. For example, the weight of the object can be directly transferred to the calculator function by depressing the weight on the touch screen display at 24a. The weight can then be multiplied by the unit price to determine the total price displayed at 24b. If the weight is changed, the total price figure at 24b will also be updated instantly. This feature provides ease of use and quick calculations.

If the battery voltage is too low during power on, it will display “Lo” for about 3 seconds and then turn off automatically. If the battery voltage becomes too low during operation, the low-batt icon will show on the screen.

The following are additional examples of using certain functions of the scale of the subject invention:

### EXAMPLE 1

### Use as a Simple 8-Digit Calculator

The scale can perform at least four arithmetic calculations (i.e., +, −, ×, ÷): e.g., To calculate “(3+8)×5=55”,

enter [3] [+] [8] [x] [5] [=] on calculator input 26 then “55” will be displayed on the upper display row 24b.

### EXAMPLE 2

### Using the Memory Function

The memory consists of 4 items, representing by the four memory buttons M1, M2, M3 & M4

a) To store items in memory:

First, enter the number (value) that you want to store in memory on the top row of the display. You can do this by using the number keypad.

Touch the [M] key in the top right corner of the display. The [M] key will blink and all four Memory buttons will show on the display (M1, M2, M3, M4).

Choose one of the 4 memory buttons, e.g., [M1] by touching it. The current figure on the upper row is then stored in M1. The [M] key will then stop blinking.

(b) To clear the memory: Touch the [MC] key. At this time, the [MC] key will blink. Choose one of the registered memory buttons, e.g., [M1] by touching it. The stored figure in M1 is then cleared. The [MC] key will then stop blinking. Repeat this process for all memory numbers that you want to delete.

(c) To recall items in memory:

The 4 items can be recalled for calculation at any time. To recall the memory, simply touch one of the memory buttons, its content will be displayed on the upper row. This comes in very handy for price computing. Simply preset and store values in the memory, then you can use them to compute prices as outlined in the next section.

### EXAMPLE 3

### Price Calculation

The scale comprises an integrated memory that is able to store and recall values even when the power is reset or the batteries changed on the scale

(a) Set the unit price:

Enter the unit price on the calculator input 26 which is displayed on the upper display row 24b

e.g., unit price $1.23/g, enter [1] [.] [2] [3] (1.23 will show on the upper display row 24b).

If the unit price was stored in the memory before (e.g., M2), simply touch the corresponding [M2] button to retrieve it.

(b) Put the object to be weighed on the platform and the weight will be displayed on the lower display row 24a. e.g., weight=35.6 g

(c) Touch the “CALC” key on the function input 27 to perform the multiplication function: Total Price=Unit Price×Weight=1.23×35.6=43.788

The total price “43.788” is then displayed on the upper display row 24b.

i.) If the weight is changed, the total price figure will also be updated instantly.

ii.) To quit this function, simply touch the [C] key (the results will still be kept on the upper row) or touch the [AC] key (the result will be cleared and 0 will show on the upper row).

### EXAMPLE 4

### Transfer the Weight Figure for Calculation

(a) The weight figure on the lower display row 24a can be copied to the upper display row 24b by simply touching it. This allows you to weigh an object and the weight will show on the lower display 24a (e.g., 35.6), if you touch the displayed number (35.6) the number will be automatically copied to the upper display row 24b.

(b) It can then be stored into the memory or used to perform other calculations.

### EXAMPLE 5

### Simple Calibration

It is recommended to allow the scale to warm up for 30 seconds before calibration.

(a) Turn the scale off and clear the platform.

(Make sure nothing is on the platform, not even the plastic tray)

(b) Place the scale on a flat stable surface that has NO vibrations and make sure there is absolutely NO air movement. (Surface must be extremely stable).

(c) Turn the scale on by pressing the ON key (Remember: make sure the silver platform is empty).

(d) When the display shows 0.0, Place a 100 gram weight on the center of the tray.

(e) Wait 5 seconds for the display to stabilize, then press and hold the MODE key until the display flashes 100.0 twice. (This may take about 6 seconds)

(f) Calibration is complete, release the MODE key and remove the weight from the tray.

While there has been shown and described what is considered to be a preferred embodiment of the invention, it will, of course, be understood that various modifications and changes in form or detail could readily be made without departing from the spirit of the invention. It is therefore, intended that the invention not be limited to the exact form and detail herein shown and described, nor to anything less than the whole of the invention herein disclosed.

1. A portable electronic weighing device comprising:
a platform on which an object is placed for weighing;
weighing circuitry in communication with said platform for weighing objects placed on said platform to provide weight data thereof;
a display having a first and second display area, said first display area for digital display of weight data of said object, and wherein said display further comprises an input device for receiving input from a user;
calculating circuitry responsive to said input device and said weighing circuitry for providing output data, said output data displayed on said second display area;
wherein said weight data is selectively transferred to said calculating circuitry through said input device by the user upon a single command without re-entering the weight data.

2. The portable electronic weighing device of claim 1 wherein said weighing circuitry comprises a transducer coupled to said platform responsive to the weight of the object to provide an analog signal indicative of the weight, and comprising analog to digital conversion circuitry for providing the weight data.

3. The portable electronic weighing device of claim 1 wherein the input device comprises a touch screen having a plurality of touch points thereon responsive to user input.

4. The portable electronic weighing device of claim 3 wherein a touch point is associated with said first display area such that when said touch point is activated, the weight data shown on the first display area is transferred to the calculating circuitry.

5. The portable electronic weighing device of claim 4 wherein the calculating circuitry comprises mathematical functions operable on the weight data.

6. The portable electronic weighing device of claim 5 wherein the mathematical functions include arithmetic calculations operable via the touch screen, the results of which are displayed in the second display area.

7. The portable electronic weighing device of claim 1 wherein the calculating circuitry further comprises storage circuitry to allow storage of weight data and output data.

8. The portable electronic weighing device of claim 5 wherein the calculating circuitry comprises price calculation circuitry.

9. The portable electronic weighing device of claim 8 wherein the price calculation circuitry comprises computing devices for receiving unit price, receiving weight data of an object placed on the platform, performing price calculation based on unit price and weight data, and displaying price calculation on the display.

10. The portable electronic weighing device of claim 9 wherein said price calculation circuitry automatically updates the price calculation upon receiving a change in weight data by performing price calculation based on unit price as previously received and newly received weight data, and displaying price calculation on the display.

11. A portable electronic weighing device comprising:
a platform on which an object is placed for weighing;
weighing circuitry in communication with said platform for weighing objects placed on said platform to provide weight data thereof; wherein said weighing circuitry comprises a transducer coupled to said platform responsive to the weight of the object to provide an analog signal indicative of the weight, and comprising analog to digital conversion circuitry for providing the weight data;
a display having a first and second display area; said first display area for digital display of weight data of said object, wherein said display comprises an input device for receiving input from a user; wherein the input device comprises a touch screen having a plurality of touch points thereon responsive to user input, wherein the user selectively transfers weight data to calculating circuitry utilizing the input device upon a single command without re-entering the weight data, said calculating circuitry responsive to said input device and said weighing circuitry for providing output data, said output data displayed on the second display area; wherein said weighing circuitry comprises price calculation circuitry, said price calculation circuitry comprising computing devices for receiving unit price from the user via the input device, receiving weight data of an object placed on the platform from the weighing circuitry, performing price calculation based on unit price and weight data, and displaying price calculation on the display.

12. The portable electronic weighing device of claim 11 wherein the calculating circuitry comprises mathematical functions operable on the weight data.

13. The portable electronic weighing device of claim 12 wherein the mathematical functions include arithmetic calculations operable via the touch screen, the results of which are displayed in the second display area.

14. The portable electronic weighing device of claim 11 wherein the calculating circuitry further comprises storage circuitry to allow storage of weight data and output data.

15. A method for price calculation based on weight of an object comprising:
placing an object on a platform to be weighed;
weighing the object with a weighing device in communication with the platform providing digital weight data;
displaying the digital weight data on a first display area;
entering a unit price for the object, said unit price displayed on a second display area;
calculating the price based on the digital weight data and unit price by a single command by a user without re-entering the digital weight data; and
displaying the price on the second display area.

16. The method of claim 15 wherein the single command is entered by a touch screen.

17. The method of claim 15 wherein a new price calculation is automatically provided upon placing another object on the platform having a different weight.
